(19) United States
(12) Patent Application Publication
(10) Pub. No.: US 2012/0192404 A1
(43) Pub. Date: Aug. 2, 2012

(54) CONCRETE SCREW AND METHOD FOR ANCHORING A CONCRETE SCREW IN A SUBSTRATE

(75) Inventors: Falk ROSENKRANZ, Wildhaus (CH); Christian Koenig, Bezau (AT); Bernhard Sander, Muenchen (DE)

(73) Assignee: Hilti Aktiengesellschaft, Schaan (LI)

(21) Appl. No.: 13/360,436

(22) Filed: Jan. 27, 2012

(30) Foreign Application Priority Data
Jan. 28, 2011 (DE) 10 2011 003 290.8

(51) Int. Cl. F16B 39/284; B23P 11/00; B25B 19/00; F16B 13/06

(52) U.S. Cl. 29/432.1; 411/80.6; 173/104

(57) ABSTRACT

A concrete screw is disclosed. The concrete screw has a shaft section, a thread section, which is arranged on the front end of the concrete screw and is provided with at least one expansion slot, and an expansion element, which is allocated to the expansion slot such that the expansion element expands the expansion slot during screw-in. A method and a tangential impact screwdriver for driving in such a concrete screw are also disclosed.

This application claims the priority of German Patent Document No. DE 10 2011 003 290.8, filed Jan. 28, 2011, the disclosure of which is expressly incorporated by reference herein.

### BACKGROUND AND SUMMARY OF THE INVENTION

The invention relates to a concrete screw as well as a method for anchoring a concrete screw in a substrate.

Screw anchors, which typically have a thread that extends almost over the entire length of the shaft, are known for anchoring loads on a concrete wall or ceiling or in comparable substrates. This is required, on the one hand, because the undercut in the substrate that is achieved with a screw anchor is relatively small and a thread-enveloping surface that is as large as possible must be available especially in cracked concrete in order to bear the loads in the concrete without provoking a shear failure along the thread enveloping. On the other hand, the load-bearing capacity of the concrete is not completely utilized in many cases, because a combined failure mechanism consisting of a concrete cone breakout in the upper two thirds of the anchoring depth and a shear failure in the lower third of the anchoring depth is observed in the case of screw anchors, because of the thread extending over the entire screw length.

Undercut anchors are also known which are normally designed so that an undercut is generated either beforehand or during anchor drive-in. The prior creation of the undercut is disadvantageous, because this process is involved and various special tools are required in order to be able to execute it with the required high level of reliability. If the undercut is created when the anchor is being driven in, the undercut anchor must be executed in a relatively involved manner in order to be able to cut into the concrete with the desired depth. Correspondingly, high production expenses arise for the undercut anchor, which in some cases is also designed to be multi-part. In addition, driving in such an undercut anchor is especially laborious if a reinforcement is struck.

An anchor bolt is also known from German Patent Document No. DE 31 39 174, which is supposed to be inserted into a cylindrical anchor hole filled with a mortar cartridge. A slot is provided in the front section of the anchor bolt, into which an expansion wedge may be pressed. In the initial state, the expansion wedge projects over the front end of the anchor element so that when the anchor element is pressed into the borehole, the expansion wedge expands the front end of the anchor element in a mushroom-shaped manner. An undercut is generated in this way, which is anchored in a mortar filling introduced into the borehole.

The object of the invention is creating an anchor, which may be inserted into concrete or similar substrates and enables high loads to be absorbed without requiring high production costs.

In order to attain this object, according to the invention, a concrete anchor is provided with a shaft section, a thread section, which is arranged on the front end of the concrete anchor and is provided with at least one expansion slot, and an expansion element, which is allocated to the expansion slot such that the expansion element expands the expansion slot during screw-in. This concrete anchor is based on the fundamental idea of being able to vary the outside diameter of the thread section. During the initial screw-in of the thread section in a borehole, the thread section has a smaller diameter so that a good first cut is produced. After the thread section has been screwed sufficiently far into the borehole, the expansion element is activated so that the thread section is spread out and has a larger outside diameter. As a result, the thread section cuts into the substrate with a larger undercut. This larger undercut may be generated quickly and with little effort at a great anchoring depth so that competitive loads may be borne.

In one embodiment, the shaft section is provided with an activation channel through which the expansion element may be activated from the side facing away from the thread section. The expansion of sides of the screw head may be controlled hereby. As a result, it is possible for the expansion to be controlled and variable, and be independent of the depth of the borehole.

In this case, the expansion element is preferably a mandrel, which can be displaced forward through the activation channel toward the thread section. This embodiment is characterized by a simple and cost-effective structure.

In another embodiment, the expansion element is a mandrel arranged on the front end of the concrete screw, which is pressed into the expansion slot when striking on the base of the borehole thereby bringing about the expansion of the thread section. An activation channel is hereby eliminated which produces a lower level of weakening of the concrete screw.

According to a preferred embodiment, it is provided that the thread section is shorter than the shaft section. This guarantees that the loads are transferred exclusively into the depth of the borehole thereby achieving a greater strength. In addition, the entire shaft of the concrete anchor does not have to be provided with thread, which reduces production costs.

The thread of the thread section is preferably a self-tapping thread. This makes it possible to dispense with cutting the thread beforehand.

To attain the above-mentioned object, a method for anchoring a concrete anchor in a substrate is also provided, in which the concrete anchor is screwed into an existing borehole and the expansion element is driven into the expansion slot during screw-in. Reference is made to the foregoing explanations regarding the resulting advantages.

The concrete anchor may be screwed in by a tangential impact screwdriver, with which the expansion element is also driven into the expansion slot. This makes it possible to drive in the concrete anchor automatically.

In this case, it is especially preferred if the expansion element is driven into the expansion slot towards the end of screw-in. In this way, the large undercut of the thread section is first brought about in the depth of the borehole so that a greater loading capacity is produced.

The expansion element is preferably driven into the expansion slot when it strikes the base of the borehole. This simplifies the method, because the expansion of the thread section may be carried out without additional process steps.

A tangential impact screwdriver is also provided according to the invention, which has an actuating element, with which an expansion element of a concrete anchor may be activated. Such a tangential impact screwdriver makes it possible to automatically drive in the concrete anchor, because the expansion element may be activated automatically when reaching a predetermined screw-in depth so that the large undercut is produced at the correct depth.

The invention is described in the following on the basis of an embodiment that is depicted in the attached drawings.

### BRIEF DESCRIPTION OF THE DRAWINGS

FIG. 1 is a schematic section of a concrete anchor at the beginning of drive-in;

FIG. 2 is a schematic side view of the thread section of the concrete anchor from FIG. 1;

FIG. 3 illustrates the concrete anchor from FIG. 1 towards the end of drive-in; and

FIG. 4 is a schematic section of the drive-in process of a concrete anchor in another embodiment.

### DETAILED DESCRIPTION OF THE DRAWINGS

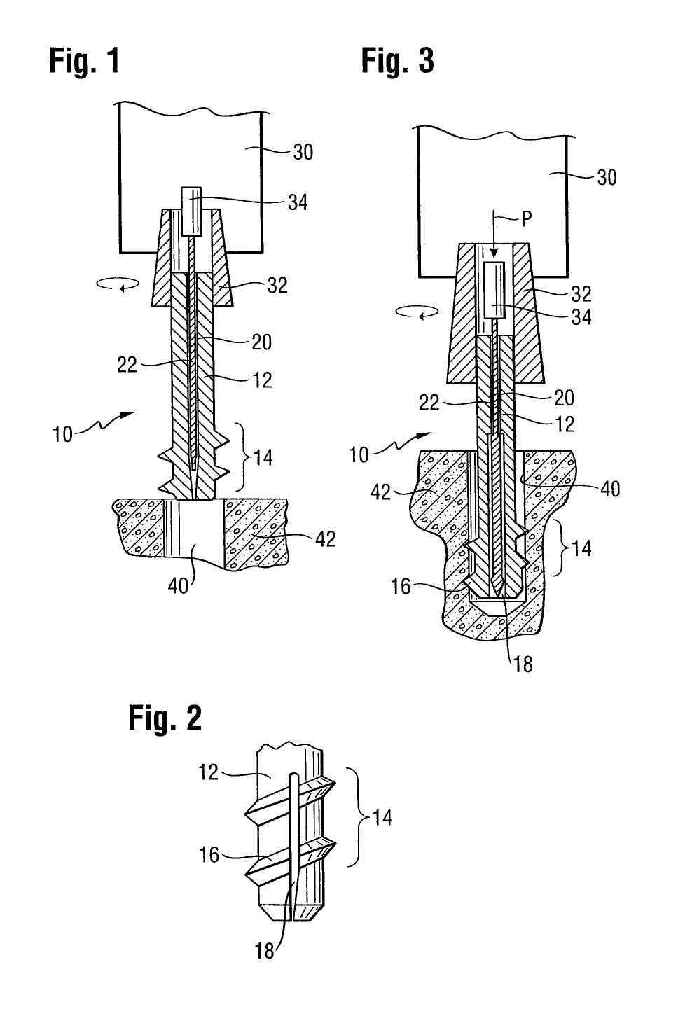

FIGS. 1 and 2 show a concrete anchor 10, which has a shaft section 12 and a thread section 14. The thread section 14 is located at the front end of the concrete anchor, and the opposing rear end is used to fasten a load. For this purpose, the rear end may be provided, for example, with an internal thread, an external thread or even a hexagonal head.

The thread section 14 here contains a single-start thread with a pitch 16, which in this case has relatively few windings, for example, two to four windings. The shaft section 12 is non-threaded.

Starting from the front end of the concrete anchor, an expansion slot 18 extends diametrically through the thread section 14 so that the concrete anchor 10 is formed in a front view by two approximately semi-circular segments, which lie on the one side and the other side of the expansion slot 18. The expansion slot 18 ends approximately in the area of the transition from the thread section 14 to the non-threaded shaft section 12. The expansion slot 18 narrows on the opposing end, i.e., on the front end of the concrete anchor (also see FIG. 1).

The concrete anchor 10 is made wholly of a conventional high-carbon steel and may be hardened especially in the area of the thread section 14. The use of stainless steel is also possible as an alternative. The thread formed by the pitch 16 is designed in this case to be self-tapping.

Extending in the center through the shaft section 12 along the longitudinal axis of the concrete anchor 10 is an activation channel 20, which leads to the expansion slot 18. Arranged in the activation channel 20 is an expansion element 22, which is designed as an elongated mandrel in this case, which projects slightly into the expansion slot 18 with its front end and with its rear end sticks out of the rear end of the concrete anchor 10.

A tangential impact screwdriver 30 shown here schematically may be used to drive in the concrete anchor 10; the tangential impact screwdriver has a jaw chuck 32 into which the concrete anchor may be clamped. In addition, the tangential impact screwdriver 30 has an actuating element 34, which may act on the expansion element 22.

When the concrete anchor 10 is supposed to be driven in, the tangential impact screwdriver 30 is used to screw it into a borehole 40, which was previously created in a mineral substrate 42 such as concrete. The diameter of the borehole 40 in this case is coordinated with the outside diameter of the thread section 14 in such a way that the thread section 14 is screwed into the borehole 40 with a comparatively small undercut. This guarantees a good first cut at the beginning of drive-in.

When the concrete anchor 10 is screwed deeper into the borehole 40, the actuating element 34 of the tangential impact screwdriver 30 is activated so that the expansion element 22 is displaced forward in the direction of arrow P. The expansion slot 18 is expanded as a result and the two segments with the pitch 16 are pushed apart, thereby enlarging the outside diameter of the pitch 16 of the thread section 14. This forces the thread formed by the pitch 16 to cut into the wall of the borehole 40 in the substrate 42 with a large undercut. As a result, a distinct thread undercut with which high loads may be borne is produced at a great anchoring depth. Because the introduction of the load is carried out very deep in the concrete, the risk of failure is very low. Overall, a good anchoring performance is produced in cracked and uncracked concrete. Because high expansion forces are generated in the borehole, it is possible to select low spacing and edge distances.

As an alternative to the embodiment shown, the thread section 14 of the concrete anchor 10 may also have multiple slots.

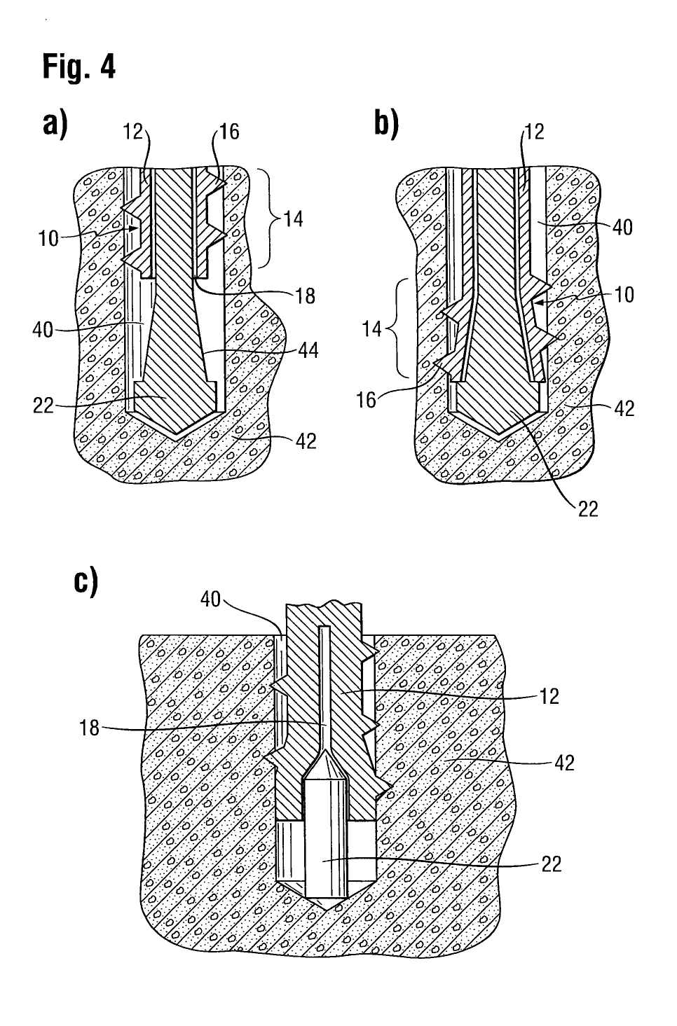

FIGS. 4a and 4b show the front section of a concrete anchor 10 in which an expansion element 22 standing on the base of the borehole 40 is used to expand the expansion slot 18.

In this case, the expansion element 22 is freely guided in a displaceable manner along the longitudinal axis on the front end of the concrete anchor 10. The expansion slot 18 divides the concrete anchor 10 into several segments in the area of the thread section 14, which makes an expansion of this area possible.

At the beginning of the screwing process (not shown), the concrete anchor 10 is inserted into the borehole 40 and, in an unexpanded state with a small outside diameter, screwed into the area of the pitch 16. At a certain depth, the expansion element 22 then strikes the base of the borehole 40 (FIG. 4a); with additional screw-in of the concrete anchor 10, the thread section 14 is expanded by the cone 44 of the now inserted expansion element 22. The outside diameter of the pitch 16 of the thread section 14 is hereby enlarged. This also forces a larger undercut of the thread with the wall of the borehole 40 in the substrate 42 in this case. The anchoring depth and the size of the undercut may be controlled via the length of the expansion element 22 and the shape thereof.

FIG. 4c shows a concrete anchor 10 of the same embodiment, wherein the expansion element 22 has another shape and length. It clearly shows that with this embodiment, the expansion slot 18 is only necessary in the front area of the concrete anchor 10 and the remaining area of the concrete anchor 10 is also not weakened. In contrast to the embodiment in FIG. 1 the activation channel shown there is also eliminated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A concrete screw, comprising:
a shaft section;
a thread section with an expansion slot; and
an expansion element, wherein the expansion slot is expandable by the expansion element.

2. The concrete screw according to claim 1, wherein the shaft section includes an activation channel and wherein the expansion element is moveable through the activation channel from a side facing away from the thread section.

3. The concrete screw according to claim 2, wherein the expansion element is a mandrel and wherein the mandrel is moveable through the activation channel toward the thread section.

4. The concrete screw according to claim 1, wherein the expansion element is a mandrel disposed on a front end of the concrete screw and wherein the mandrel is moveable into the expansion slot by a striking of the mandrel on a base of a borehole.

5. The concrete screw according to claim 1, wherein the thread section is shorter than the shaft section.

6. The concrete screw according to claim 1, wherein the shaft section does not have a thread.

7. The concrete screw according to claim 1, wherein a pitch of the thread section is a self-tapping thread.

8. A method for anchoring a concrete screw in a substrate, wherein the concrete screw includes:
a shaft section;
a thread section with an expansion slot; and
an expansion element;
comprising the steps of:
screwing the concrete screw into a borehole; and
driving the expansion element into the expansion slot during screw-in of the concrete screw in the substrate.

9. The method according to claim 8, wherein the concrete screw is screwed-in by a tangential impact screwdriver and wherein the expansion element is driven into the expansion slot by the tangential impact screwdriver.

10. The method according to claim 8, wherein the expansion element is driven into the expansion slot towards an end of the screw-in.

11. The method according to claim 8, wherein the expansion element is driven into the expansion slot by striking the expansion element on a base of the borehole.

12. A tangential impact screwdriver, comprising:
a jaw chuck; and
an actuating element, wherein an expansion element of a concrete anchor is moveable by the actuating element.
